(19) United States
(12) Patent Application Publication
(10) Pub. No.: US 2021/0342185 A1
(43) Pub. Date: Nov. 4, 2021

(54) RELOCATION OF WORKLOADS ACROSS DATA CENTERS

(71) Applicant: Hewlett Packard Enterprise Development LP, Houston, TX (US)

(72) Inventors: Bhakthavatsala K NAIDU, Bangalore (IN); Prabhanjan GURURAJ, Bangalore (IN)

(21) Appl. No.: 17/224,869

(22) Filed: Apr. 7, 2021

(30) Foreign Application Priority Data
Apr. 30, 2020 (IN) IN 202041018559

(51) Int. Cl. G06F 9/48; G06F 1/329; G06F 9/50

(52) U.S. Cl. CPC G06F 9/4893; G06F 1/329; G06F 2209/5022; G06F 9/5094; G06F 9/5077

(57) ABSTRACT

Example techniques for relocation of workloads across data centers of a data center system are described. A target for the data center system for power cost reduction or carbon footprint reduction or both is received. Power source information pertaining to power sources that power data centers of the data center system is also received. A workload to be relocated is identified based on characteristics of the workload, the power source information, and the target.

### BACKGROUND

A data center may include computing devices, such as servers, and associated components, such as storage devices and network devices. The computing devices in the data center may host workloads, such as applications, that perform functions, for example, to cater to user requests.

### BRIEF DESCRIPTION OF DRAWINGS

The following detailed description references the figures, wherein:

FIG. 1 illustrates a system for facilitating relocation of workloads across data centers, according to an example implementation of the present subject matter.

FIG. 2 illustrates a network environment having a system and a data center system in which workloads may be relocated, according to an example implementation of the present subject matter.

FIG. 3 illustrates a network environment having a system and data centers, according to an example implementation of the present subject matter.

FIG. 4 illustrates a method for facilitating relocation of workloads across data centers, according to an example implementation of the present subject matter.

FIG. 5 illustrates a method for determining whether a power source that supplies power to a data center is to be switched and whether a workload is to be relocated, according to an example implementation of the present subject matter.

FIG. 6 illustrates a computing environment implementing a non-transitory computer-readable medium for facilitating relocation of workloads across data centers, according to an example implementation of the present subject matter.

### DETAILED DESCRIPTION

Workloads, such as applications, may be hosted in computing devices, such as servers, in a data center. Hosting of workloads consumes electric power, which is an expense for an organization owning the data center. Further, a power source, such as a thermal power plant, powering the data center may emit carbon dioxide into the atmosphere for generating electric power for the data center, thereby increasing a carbon footprint of the organization. An organization owning a plurality of data centers may incur a significant cost due to power consumption of the data centers. Further, the data centers of the organization may have a considerable carbon footprint.

The present subject matter relates to relocation of workloads across data centers, such as across data centers belonging to an organization. The present subject matter facilitates reduction of cost expenditure and carbon footprint of the data centers.

In accordance with an example implementation, a data center system may include a plurality of data centers, such as a first data center and a second data center. The data center system may be managed or owned by an organization. The data centers of the data center system may be powered by different power sources. For example, the first data center may be powered by a thermal power plant and the second data center may be powered by a solar farm. Further, a cost incurred per unit of power consumed may be different for the first data center and the second data center.

The organization owning or managing the data center system may have targets pertaining to power consumption of the data center system. The targets may include, for example, a power cost reduction target, which indicates an amount by which power cost of the data center system is to be reduced. For example, the power cost reduction target may indicate that the power cost in the current year should be 20% less than that in the previous year. The power cost reduction target may also be referred to as total cost of ownership (TCO) reduction target, as power cost impacts TCO of a data center. The targets may also include a carbon footprint reduction target, which indicates an amount by which the carbon footprint of the data center system is to be reduced.

In an example, power source information of the data center system may be received. The power source information may indicate, for example, a first cost incurred for obtaining power for the first data center, a second cost incurred for obtaining power for the second data center, and type of power sources that power the first data center and the second data center. A type of a power source may provide an indication of a carbon footprint generated by the power source for generating a unit of electric energy. For instance, the type of the power source may indicate whether the power source is renewable or non-renewable, and a source or a fuel (e.g., coal, natural gas, or wind) used by the power source for generating the power.

Based on the targets and the power source information, it may be determined that a workload is to be relocated from the first data center to the second data center. For example, if the second cost is less than the first cost, or if the power source powering the second data center has a lesser carbon footprint than that powering the first data center, it may be determined that a workload from the first data center is to be relocated to the second data center, to achieve the targets.

Further, a workload to be relocated from the first data center to the second data center may be identified based on characteristics of the workloads hosted in the first data center and the targets. For instance, an amount of power consumption to be shifted from the first data center to the second data center may be assessed based on the targets. Subsequently, a set of workloads that, if relocated, facilitate achieving such a shifting may be identified based on the characteristics of the workloads. The characteristics of the workloads may include power consumption of the workloads or other characteristics, such as resource consumption, that can be used to derive power consumption of the workloads.

In an example, a data center of the data center system may be connected to more than one power source, each of which may be capable of supplying electric power to the data center. In such a case, a power source that is to supply power to the data center may be determined based on the power source information and targets of the organization. For instance, if a data center is powered by a thermal power plant and if a solar farm can supply power to the data center, the power may be obtained from the solar farm to achieve the carbon footprint target. Further, a decision as to whether a workload is to be relocated can be taken based on whether the power source is to be switched. For instance, if the power source of a data center is to be switched, it may further be decided that workloads are not to be relocated from the data center or that a lesser number of workloads are to be relocated.

The present subject matter facilitates reducing TCO and carbon footprint of an organization having a data center system. By analyzing targets of an organization, cost information, and characteristics of workloads, the present subject matter identifies the workloads that are to be relocated to achieve the targets. Therefore, techniques of the present subject matter can be utilized to achieve quantitative targets, such as a target to achieve 20% reduction of TCO as compared to previous year. Further, the switching of a power source from which the power for a data center is obtained also helps achieving the targets. Thus, the present subject matter facilitates making decisions regarding switching of power sources and relocation of workloads to achieve the targets.

The following description refers to the accompanying drawings. Wherever possible, the same reference numbers are used in the drawings and the following description to refer to the same or similar parts. While several examples are described in the description, modifications, adaptations, and other implementations are possible and are intended to be covered herein.

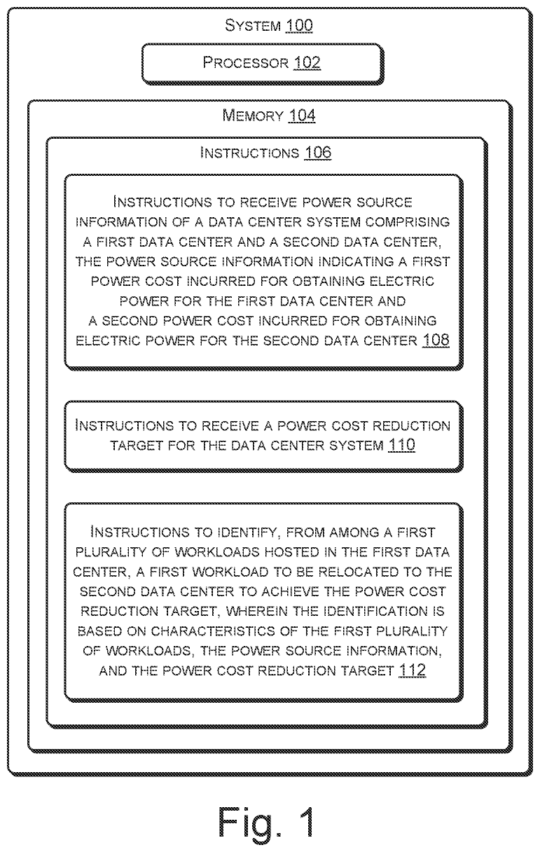

FIG. 1 illustrates a system 100 for facilitating relocation of workloads across data centers, according to an example implementation of the present subject matter. The system 100 may be implemented as a computing device, such as a desktop computer, a laptop computer, a server, or the like. The system 100 includes a processor 102 and a memory 104 coupled to the processor 102.

The processor 102 may be implemented as a microprocessor, a microcomputer, a microcontroller, a digital signal processor, a central processing unit, a state machine, a logic circuitry, and/or any device that can manipulate signals based on operational instructions. Among other capabilities, the processor 102 may fetch and execute computer-readable instructions 106 included in the memory 104. The computer-readable instructions 106, hereinafter referred to as instructions 106, include instructions 108, instructions 110, and instructions 112. The functions of the processor 102 may be provided through the use of dedicated hardware as well as hardware capable of executing machine readable instructions.

The memory 104 may include any non-transitory computer-readable medium including volatile memory (e.g., RAM), and/or non-volatile memory (e.g., EPROM, flash memory, Memristor, etc.). The memory 104 may also be an external memory unit, such as a flash drive, a compact disk drive, an external hard disk drive, or the like.

In addition to the processor 102 and the memory 104, the system 100 may also include interface(s) and system data (not shown in FIG. 1). The interface(s) may include a variety of machine-readable instructions-based interfaces and hardware interfaces that allow interaction with a user and with other communication and computing devices, such as network entities, web servers, and external repositories, and peripheral devices. The system data may serve as a repository for storing data that may be fetched, processed, received, or created by the instructions.

In operation, the system 100 may facilitate relocation of workloads across data centers of a data center system (not shown in FIG. 1) by executing the instructions 106. The data center system may include a plurality of data centers, such as a first data center and a second data center. Each data center of the data center system may host a plurality of workloads. For instance, the first data center may host a first plurality of workloads and the second data center may host a second plurality of workloads. In an example, the data center system may be owned, managed, or both by an organization. Accordingly, the workloads hosted in the data center system may belong to the organization.

The processor 102 may execute the instructions 108 to receive power source information of the data center system. The power source information may be received, for example, from the memory 104 or from another computing device (not shown in FIG. 1). The power source information may indicate a first power cost (also referred to as a first cost) incurred for obtaining electric power for the first data center and a second power cost (also referred to as a second cost) incurred for obtaining electric power for the second data center. The power for the first data center and the second data center may be supplied by a first power source and a second power source (not shown in FIG. 1) respectively. In an example, the first power cost and the second power cost may be costs incurred for obtaining one unit of power for the first data center and the second data center respectively. The first power cost may be less or more than the second power cost. In an example, the power source information may also indicate types of the first power source and the second power source, which may provide an indication of carbon footprints of the first power source and the second power source respectively.

The processor 102 may execute the instructions 110 to receive a target for the data center system. The target may be received, for example, from the memory 104 or from another computing device (not shown in FIG. 1). The target may pertain to power consumption of the data center system. In an example, the target may be a power cost reduction target, which may specify an amount by which power cost of the data center system is to be reduced. For example, the power cost reduction target may specify that the power cost in the current year should be 20% less than that in the previous year. In another example, the target may be a carbon footprint reduction target, which indicates an amount by which the carbon footprint of the data center system is to be reduced. In a further example, both the power cost reduction target and the carbon footprint reduction target may be received.

Based on the target, the processor 102 may determine whether a workload in the first data center is to be relocated to the second data center. For instance, if the second power cost is less than the first power cost, the processor 102 may determine that a workload in the first data center is to be relocated to the second data center, to achieve the power cost reduction target. Similarly, if the carbon footprint of the second power source is less than that of the first power source, the processor 102 may determine that a workload in the first data center is to be relocated to the second data center, to achieve the carbon footprint reduction target. Based on the determination, the processor 102 may identify a workload, such as a first workload or a second workload, from among the first plurality of workloads for relocation to the second data center to achieve the target.

The identification of the first workload may be based on characteristics of the first plurality of workloads, the power source information, and the target. The characteristics of the first plurality of workloads may include power consumption of each of the first plurality of workloads. In an example, the processor 102 may assess an amount by which power consumption of the first data center is to be reduced (and a corresponding amount by which power consumption of the second data center is to be increased) to achieve the power cost reduction target, based on the power source information and the power cost reduction target. Similarly, the processor 102 may assess an amount by which power consumption of the first data center is to be reduced to achieve the carbon footprint reduction target, based on the power source information and the carbon footprint reduction target. Subsequently, a workload or a set of workloads that consume the assessed amount of power consumption may be identified based on characteristics of the workloads as suitable for relocation. The identification of workloads for relocation may be performed by the processor 102 based on execution of the instructions 112.

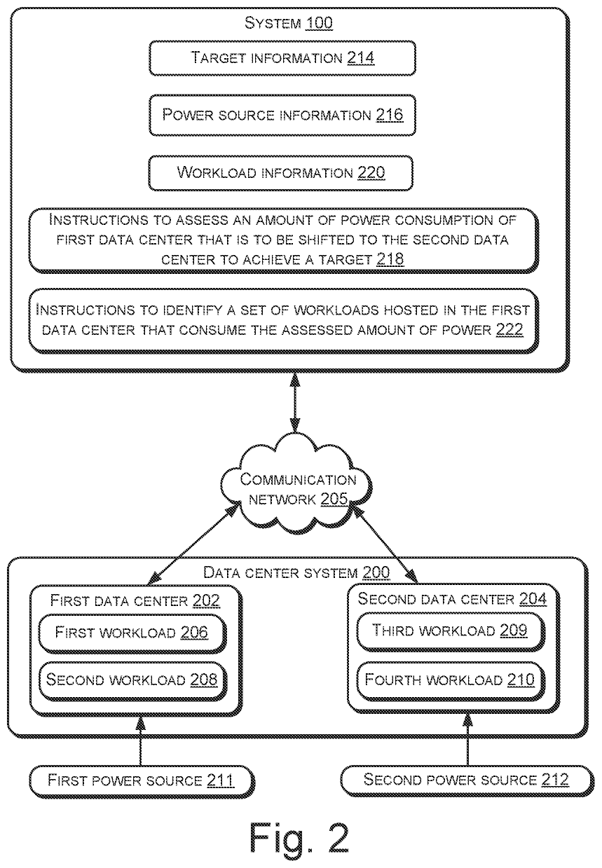

FIG. 2 illustrates a network environment having the system 100 and a data center system 200 in which workloads may be relocated, according to an example implementation of the present subject matter. The data center system 200 includes a first data center 202 and a second data center 204. The data centers of the data center system 200 may be distributed geographically, such as spread across regions of a country or across countries. Although the system 100 is shown external to the data center system 200, in an example, the system 100 may be part of a data center of the data center system 200. For instance, the system 100 may be a computing device of the first data center 202 or of the second data center 204.

The system 100 may communicate with the data centers of the data center system 200 over a communication network 205. The communication network 205 may be a wireless or a wired network, or a combination thereof. The communication network 205 may be a collection of individual networks, interconnected with each other and functioning as a single large network (e.g., the internet or an intranet). Examples of such individual networks include Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 205 may include various network entities, such as transceivers, gateways, and routers.

In an example, the first data center 202 and the second data center 204 may each be an on-premises (also referred to as “on-prem”) data center, which may refer to a data center that may be privately owned, controlled, or both by an organization. On-prem data centers may be housed by organizations in their own facilities and may be maintained by the organizations themselves. On-prem data centers can be used to run private clouds. In another example, the data centers of the data center system 200 may be part of a public cloud, which refers to a framework in which the data centers are owned by a third-party cloud service provider that provides resources of the data centers, such as storage and compute, to customers on demand.

Each data center may include a plurality of computing devices (not shown in FIG. 2) for hosting workloads, which may be, for example, applications, such as analytics applications and enterprise resource planning (ERP) applications. For instance, the first data center 202 may host a first workload 206 and a second workload 208. Similarly, the second data center 204 may host a third workload 209 and a fourth workload 210. The workloads hosted in the first data center 202 may be referred to as the first plurality of workloads and the workloads hosted in the second data center 204 may be referred to as a second plurality of workloads.

If a data center is an on-prem data center, a workload hosted in the data center may belong to the organization that owns and/or controls the data center. The workloads may be utilized by the organization for performing its functions. For instance, an ERP application may be utilized by an organization for receiving and processing orders. If the data center is part of a public cloud, the workload hosted in the data center may belong to a customer of the organization that owns and/or controls the public cloud.

The hosting of a workload in a data center consumes resources of the data center, such as storage resources, memory resources, network resources, and compute resources. The consumption of resources in turn causes consumption of electric power, also referred to as power. The data center may also consume power for operating its cooling system, which facilitates in maintaining the temperature of the computing devices. The power for a data center may be received from a power source. For instance, the first data center 202 may receive power from a first power source 211 and the second data center 204 may receive power from a second power source 212.

The first power source 211 may be of a first type and the second power source 212 may be of a second type. A type of power source may indicate a fuel or a source from which a power source generates power. For instance, the first power source 211 may be of a thermal power plant type, which indicates that the first power source 211 uses coal as fuel, and the second power source 212 may be of a solar farm type, which indicates that the second power source 212 generates power from solar energy. A type of power source may also indicate whether the power source is a renewable power source or a non-renewable power source. A power source of the first type may have a carbon footprint different than a power source of a second type. For instance, a solar farm or a nuclear power plant may have a lesser carbon footprint than a thermal power plant.

The power source may be connected to a data center through a power grid (not shown in FIG. 2) or directly. The direct connection may be possible, for example, when the power source is located in proximity to the data center. Such a power source may be owned by the organization that owns the data center. In an example, the power from a power source may be delivered to a data center by a power supplier. The power supplier may also be referred to as a power seller, an electric company, or a power company. The power supplier may procure power from a power source and deliver the procured power to the data center through a power grid. In an example, the power demands of a data center may be satisfied by more than one power source. For instance, a first power supplier (not shown in FIG. 2) may supply power procured from more than one power source to cater to the power demands of the first data center 202. In another example, a portion of the power for the first data center 202 may be obtained from the first supplier through the power grid while the remainder of the power may be obtained from a power source that is directly connected to the first data center 202.

A cost incurred to obtain power for the first data center 202 may be different than a cost incurred to obtain power for the second data center 204. The difference in costs may be due to the difference in costs involved in power generation between the regions in which the first power source 211 is deployed and the second power source 212 is deployed. The difference may also be due to the pricing of the first power supplier and that of a second power supplier that supplies power to the second data center 204. In an example, the difference may be because the second power source 212 may be owned by the organization, while the first power source 211 may be not. The differences in the cost may cause the cost incurred for hosting a workload in the first data center 202 to be different from that incurred for hosting the workload in the second data center 204. In some cases, the carbon footprint of hosting a workload in the first data center 202 may be different than that of hosting the workload in the second data center 204. The difference may be due to a difference between the first type of power source and the second type of power source.

In accordance with the present subject matter, the organization that owns and/or controls the data center system 200 may reduce the power cost incurred and carbon footprint of the data center system 200 by re-distributing the workload and selecting the power source. A reduction in the power cost results in a reduction in a total cost of ownership (TCO) of the organization, which is the overall cost incurred by the organization for owning and operating the data center system 200. A reduction in the carbon footprint reduces the stress on environment caused by the data center system 200. Further, a reduced carbon footprint may make the data center system 200 compliant with environment-related policies and make the organization eligible for receiving incentives provided by governments governing regions in which the data centers are deployed.

The organization may have a power cost reduction target and a carbon footprint reduction target indicating amounts by which the power cost and carbon footprint of the data center system 200 is to be reduced. The power cost reduction target may also be referred to as a TCO reduction target or a TCO target, as the reduction of power cost causes reduction of the TCO. Further, the carbon footprint reduction target may be referred to as a carbon footprint target.

To achieve the targets, in an example, the system 100 may relocate workloads across data centers. For instance, to achieve the TCO target, workloads may be moved from a data center incurring a higher power cost to a data center incurring lower power cost. Similarly, to achieve the carbon footprint target, workloads may be moved from a data center powered by a power source causing a higher carbon footprint to a data center powered by a power source causing a lower carbon footprint.

In an example, the targets may be quantitative targets. For instance, the target in the current year for power cost may be 20% or $20 million less than that in the previous year. In another example, the carbon footprint in the current year can have a target to be 10% or 200 metric ton less than that in the previous year. To ensure that such quantitative targets are achieved, in an example, the system 100 may identify workloads that, if relocated, would help achieve the targets.

The system 100 may receive target information 214, which may include the TCO target and the carbon footprint target. The target information 214 may be received, for example, from a user, such as an administrator of the data center system 200. The target information 214 may be stored in the memory 104 (not shown in FIG. 2). The target information 214 may indicate an aggressiveness with which the relocation of workloads is to be carried out. For instance, a large value of the TCO target or the carbon footprint target may indicate that a large amount of workload relocation is to be performed to achieve the targets. Contrarily, a relatively small value of the TCO target or the carbon footprint target may indicate that less number of workload relocations may be sufficient to achieve the targets. Further, the values of the TCO target and the carbon footprint target may indicate the priority to be provided to reducing TCO and to reducing carbon footprint. For instance, if a percentage value of the TCO target is higher than a percentage value of the carbon footprint target, more priority is to be given to reducing the TCO than reducing the carbon footprint.

In an example, the achievement of the TCO target may cause deviation from the carbon footprint target and vice-versa. This may be because a power cost at which a power source with a smaller carbon footprint supplies power may be more than that at which a power source with a larger carbon footprint supplies power. Accordingly, while workloads may have to be relocated to the data center powered by the power source with lesser carbon footprint to achieve the carbon footprint target, workloads may have to be relocated to the data center powered by the power source with larger carbon footprint for achieving the TCO target. In such a case, the system 100 may determine a direction of relocation (i.e., a data center from which a workload is to be relocated and a data center to which the workload is to be relocated) based on values of the TCO target and the carbon footprint target. For instance, a higher percentage value of the carbon footprint target as compared to that of the TCO target may indicate that workloads are to be relocated from a data center powered by a non-renewable power source to one powered by a renewable power source, even if such a relocation causes an increase of the TCO. While priority may be given to the higher-valued target in the short term, the system 100 may control the extent of relocations on either direction such that both the targets are satisfied in the long run, such as over a period of 1 year, for which the targets are specified. The direction of relocation in case of conflicting targets may also be determined based on an input of a user, such as an administrator of the data center system 200.

The system 100 may also receive power source information 216, which includes various details regarding the power sources and power suppliers that supply power to the data centers of the data center system 200. The power source information 216 may be received, for example, from the power suppliers or the power sources. The power source information 216 includes a first power cost, which is a cost at which power from the first power source 211 is supplied to the first data center 202, and a second power cost, which is a cost at which power from the second power source 212 is supplied to the second data center 204. In an example, the first power cost and the second power cost may be the cost charged by the first power supplier and the second power supplier for delivering power from the first power source 211 and the second power source 212 to the first data center 202 and the second data center 204 respectively. In another example, the first power cost and the second power cost may be charged by the first power source 211 and the second power source 212 respectively.

The power source information 216 may also indicate the type of the first power source 211 (i.e., the first type) and the type of the second power source 212 (i.e., the second type). In an example, a carbon footprint value associated with the first type and that associated with the second type may be referred to as a first carbon footprint and a second carbon footprint respectively and may be part of the power source information 216. The carbon footprint value associated with a type of a power source may refer to an average carbon footprint of a power source of the type for generating a unit of energy. Such values may be received, for example, from governmental agencies or international agencies dealing with power sources.

The various details of the power source information 216 may be received, for example, from the first power source 211, the second power source 212, the first power supplier, and the second power supplier. Further, the power source information 216 may be stored in the system 100, such as in the memory 104. The power source information 216 may include other details as well, such as a reliability of a power source or a reliability of a power supplier that supplies power to a data center. Overall, the power source information 216 may include details that can be used to make an informed decision as to whether relocation of workloads can facilitate achieving the targets.

In an example, the number of workloads to be relocated from one data center to another may depend on the values of the TCO target, the carbon footprint target, the first power cost, the second power cost, the first carbon footprint, and the second carbon footprint. For instance, if the first power cost is more than the second power cost, the number of workloads to be relocated from the first data center 202 to the second data center 204 is higher for a larger value of the TCO target. The number of workloads to be relocated for satisfying the TCO target may also depend on a difference between the first power cost and the second power cost. For instance, the number of workloads to be relocated for satisfying the TCO target may be lesser for a greater difference between the first power cost and the second power cost. Similarly, the number of workloads to be relocated for satisfying the carbon footprint target may depend on a difference between the first carbon footprint and the second carbon footprint.

In an example, to determine the number of workloads to relocate, the system 100 may assess an amount of power consumption of the first data center 202 that is to be shifted to the second data center 204. Such an assessment may be based on the target information 214 and the power source information 216 and may be performed by execution of instructions 218. The system 100 may then determine the number of workloads to be relocated that would result in shifting of the assessed amount of power consumption. For instance, consider that the amount of power consumption to be shifted is assessed to be 200 KW. Consider also that one workload causes consumption of 1 KW of power. In such a case, the system 100 may determine that 200 workloads are to be shifted from the first data center 202 to the second data center 204. The determination of power consumed by a workload will be explained later.

Overall, by considering the power source information 216 in combination with the target information 214, a decision of whether a relocation is to be performed may be made, a direction of relocation may be determined, and a number of workloads to be relocated may be determined.

In an example, if the data center system 200 hosts several distinct workloads, the power consumption caused by hosting one workload may be different from that caused by hosting another workload. In such a case, the reduction of TCO or reduction of carbon footprint achieved by relocation of one workload may be different from that achieved by relocation of the other workload. Accordingly, the system 100 may also determine particular workloads to be relocated based on the power source information 216 and the target information 214.

To identify the workloads to relocate and to determine the number of workloads to relocate, the system 100 may utilize power consumption caused by a workload. In an example, the power consumption caused by a workload may refer to the power consumption caused over a period of time, such as an hour, a day, or the like. To facilitate utilization of the power consumption, the system 100 may have workload information 220 stored thereon, which includes the power consumption caused by workloads hosted in the data center system 200. For instance, the workload information 220 may include first power consumption, which is the power consumption of the first workload 206, and second power consumption, which is the power consumption of the second workload 208. In an example, the workload information 220 may be a lookup table.

In an example, the power consumption of a workload may be assessed by monitoring power consumption of a computing device hosting the workload over a period of time. In another example, the power consumption of a workload may be computed based on resource consumption, such as memory consumption, processor consumption, and storage consumption, of the workload. To perform the computation based on the resource consumption, power consumption for a given amount of processor consumption, memory consumption, storage consumption, or the like may be utilized as inputs. The power consumption may be computed also based on a runtime duration of the workload (which may refer to a duration for which the workload runs for each initiation of the workload) and a workload pattern of the application (which may indicate a frequency at which the workload is invoked and is operated). The computation of the power consumption based on the aforesaid parameters may be performed, for example, by the system 100 or by a computing device that hosts the workload. The power consumption of a workload, the parameters that are used to compute the power consumption, or both may be interchangeably referred to as characteristics of the workload.

The workload information 220 may be used in combination with the power source information 216 and the target information 214 to identify the workloads to be relocated. For instance, if, based on the first carbon footprint, the second carbon footprint, and the carbon footprint target, it is determined that a particular amount of power consumption of the first data center 202 is to be shifted to the second data center 204, the system 100 may identify workloads hosted in the first data center 202 that consume the particular amount of power for relocation to the second data center 204. In an example, the identification of the set of workloads may be performed by execution of instructions 222. Further, the relocation of a workload may involve relocation of a virtual machine (VM) or a container hosting the workload.

In an example, the movement of the workloads from the first data center 202 to the second data center 204 may be accompanied by a movement of workloads in the opposite direction, i.e., from the second data center 204 to the first data center 202. In such a case, the workloads to be relocated may be identified such that the net power consumption shifted from the first data center 202 to the second data center 204 may equal the assessed amount.

In an example, while selecting the workloads for relocation, the system 100 may consider additional workload characteristics in addition to the aforesaid workload characteristics. For instance, the system 100 may also check if the workload is stateless to determine whether the workload can be relocated. A stateless workload is one that does not save data of a client generated in one session for use in a subsequent session with the client. Example of a stateless workload is a load-balancer workload. A stateful workload saves data of the client from each session and uses the data during the subsequent session with the client. Example of a stateful workload is a workload utilizing a database. The system 100 may consider a stateless workload more favorably for relocation than a stateful workload, as the overhead for relocation of a stateless workload is less than that for relocation of a stateful workload. The information as to whether the workload is stateless or not may be provided as part of the workload characteristics.

The additional workload characteristics may further include performance targets associated with a workload. The performance targets associated with the workload may be specified in service level agreement (SLA) parameters associated with the workload. The performance targets may include, for example, a maximum response time, which may be a time within which the workload is expected to provide a response for a request received from a client. In an example, the system 100 may determine whether a workload identified for relocation can satisfy its performance targets after its relocation. If it is determined that the workload may not satisfy the targets after relocation (such as due to increased latency), the system 100 may determine that the workload is not to be moved. Further, workloads that may not have stringent performance targets may be considered more favorably for relocation. An in-house workload, which is not to interact with a client, may be a workload having non-stringent performance targets. The consideration of the workload characteristics, in addition to the power source information 216 and the target information 214, ensures that informed decisions are taken regarding relocation of workloads and that the targets are achieved.

In an example, for deciding regarding the relocation of workloads, the system 100 may also consider resource availability of data centers as well. For instance, before relocation of a set of workloads to the second data center 204, the system 100 may determine whether the second data center 204 has sufficient resources for hosting the set of workloads. Further, prior to moving a workload to the second data center 204, the system 100 may repurpose the second data center 204. The repurposing may involve performing actions that facilitate the second data center 204 to host the relocated workload. The actions may include, for example, switching on servers in the second data center 204 that are to host the relocated workloads, installing operating systems on which the relocated workloads are to run in the servers, modifying storage and compute resources of the second data center 204 to accommodate the relocated workloads, and the like. The repurposing may also involve reorganizing workloads in the second data center 204, such as by relocating workloads in one computing device of the second data center 204 to another, to accommodate the relocated workloads. Further, the system 100 may perform various steps to reduce downtime of workloads due to relocation. The steps may include cloning a template of a VM/container hosting the workload and bringing up the VM/container from the template after its relocation.

In an example, the power cost incurred by a data center may vary over time, such as due to the drop in demand for power or an increase in generation. Accordingly, the first power cost may become less or more than the second power cost over time. The system 100 may monitor the changes in the power cost and may accordingly make decisions regarding relocation. For instance, if the first power cost reduces and becomes less than the second power cost, the system 100 may decide that the direction of relocation is to be reversed. Accordingly, workloads hosted in the second data center 204 may be relocated to the first data center 202. In an example, if the first workload 206 was relocated to the second data center 204 because the second power cost was less than the first power cost, the system 100 may again relocate the first workload 206 to the first data center 202 when the first power cost becomes less than the second power cost. Further, in an example, the system 100 may schedule execution of some workloads that are not time-sensitive at a time when the power cost is less. For instance, a workload that is to be once in a day may be scheduled for execution at a time of the day when the power cost is the cheapest. Thus, the system 100 utilizes the dynamic changes in the power costs to facilitate achieving the targets.

In some cases, the power source or power supplier that supplies power to a data center can be switched. Such an ability to switch the power source or the power supplier can augment the ability to achieve the targets, as will be explained below.

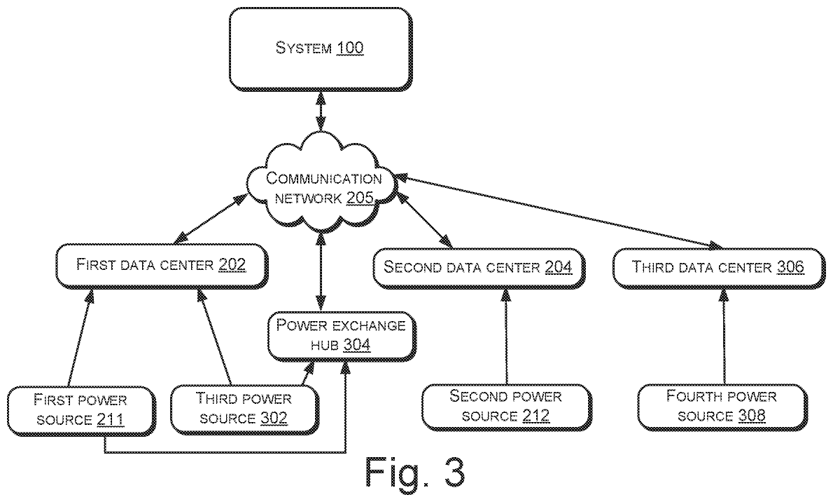

FIG. 3 illustrates a network environment having the system 100 and data centers, according to an example implementation of the present subject matter. The data center system 200 is not shown herein for the sake of clarity. As illustrated, the first data center 202 may be connected to more than one power source, such as the first power source 211 and a third power source 302, and may be capable of receiving power from one or more of the power sources. In an example, the power from the third power source 302 can be delivered by a third power supplier (not shown in FIG. 3) that is different than the first power supplier. In another example, the third power source 302 can deliver power to the first data center 202 without the involvement of a power supplier. The third power source 302 may be of a different type than the first power source 211. For instance, the first power source 211 may be a non-renewable power source and the third power source 302 may be a renewable power source. Accordingly, carbon footprint of the third power source 302 may be different than that of the first power source 211. Further, the power cost at which power from the third power source 302 can be supplied to the first data center 202 may be different than the first power cost and may be referred to as a third power cost. Accordingly, the power source information 216 includes the third power cost and the type of the third power source 302. The power source information 216 may also indicate a carbon footprint value associated with the type of the third power source 302, also referred to as a third carbon footprint (not shown in FIG. 3).

Based on the power source information 216 and the target information 214, the system 100 may determine whether the power source from which the first data center 202 obtains power is to be switched from the first power source 211 to the third power source 302. For instance, the system 100 may decide to switch the power source of the first data center 202 from the first power source 211 to the third power source 302 based on the cost and carbon footprint of the two power sources. In a further example, the decision as to whether to switch the power supply may be taken based on the details regarding the second power source 212 as well. For instance, if the second power cost is less than the third power cost, if the second power source 212 has a lower carbon footprint, and if the second data center 204 has sufficient resources to handle workloads relocated from the first data center 202, the system 100 may determine that no switching of power supply is to be performed.

In an example, the determination as to whether workloads are to be relocated to the second data center 204 may be taken based on whether the power supply is to be switched to the third power source 302. For instance, if the system 100 determines that a target can be achieved by switching the power source of the first data center 202, no relocation of workloads may be performed. In another example, the identification of workloads, such as the first workload 206, to be relocated to the second data center 204 may be based on whether the power supply is to be switched. For instance, more workloads or heavier workloads may be selected for relocation if it is decided that the power source is not to be switched. As will be understood from the above examples, the decisions regarding switching of power supply and the decisions regarding relocation of workloads may be mutually dependent on each other. Such mutually dependent decisions may facilitate achieving the targets efficiently.

In an example, the switching of power source may be facilitated by a power exchange hub 304. The power exchange hub 304 may be connected to the first power source 211 and the third power source 302. In an example, if the power from a power source is supplied to the first data center 202 by a power supplier, the power supplier may be connected to the power exchange hub 304, instead of or in addition to the power source. The power exchange hub 304 may receive the first power cost, the third power cost, and information about the first power source 211 and the third power source 302, such as the types of the first power source 211 and the third power source 302. Further, the power exchange hub 304 may transmit the received information to the system 100. The power exchange hub 304 may also receive and transmit information about changes in the power costs. Accordingly, the system 100 may identify the power costs and may make dynamic decisions regarding switching of the power source and relocation of workloads. The power exchange hub 304 may switch the power source in response to an instruction to that effect from the system 100. In an example, the switching of the power source may be achieved by switching a power supplier.

In the examples provided above, the relocation of workloads is explained in view of targets applicable to the data center system 200. In an example, there may be targets specific to individual data centers. For instance, the first data center 202 may have its own TCO target and its own carbon footprint target. Such targets may be different than the targets provided for the data center system 200. The data center-specific targets may be provided, for example, to comply with environment-related regulations or to leverage incentives provided by governments governing the region in which the first data center 202 is deployed. For instance, the organization may be eligible for waivers in power tariffs if the carbon footprint or power consumption of the first data center 202 is below a certain level. Accordingly, the TCO target or the carbon footprint target of the first data center 202 may be more than that of the data center system 200.

To achieve both the data center-specific targets and data center system targets, the system 100 may consider both these sets of targets for making decisions for switching the power supply and relocation of workloads from the first data center 202, or both. For instance, the system 100 may decide to switch power supply of the first data center 202 based on the target for the first data center 202 and may perform relocation of workloads to achieve targets for the data center system 200. Thus, the present subject matter facilitates an organization to achieve its targets both at a local and a global level.

Although the relocation of workloads is explained with reference to two data centers, the techniques of the present subject matter can be applied for data center systems having more than two data centers. When there are more than two data centers in the data center system 200, the system 100 may select a target data center to which a workload is to be relocated for achieving the targets. For instance, the data center system 200 may include a third data center 306 that is powered by a fourth power source 308. Accordingly, the power source information 216 may indicate a fourth power cost incurred for obtaining electric power for the third data center 306 from the fourth power source 308 and a type of the fourth power source. In such a case, the system 100 may consider the second power cost, the fourth power cost, the second type of power source, and a type of the fourth power source, to select the data center to which a workload from the first data center 202 is to be relocated.

Further, in an example, both the second data center 204 and the third data center 306 may be selected as target data centers for receiving workloads from the first data center 202. For instance, in addition to relocating the first workload 206 to the second data center 204, the system 100 may also relocate the second workload 208 to the third data center 306. Similarly, workloads from more than one data center may be relocated to one or more target data centers.

In an example, in addition to the power source information 216, a set of metrics (not shown in FIG. 2) related to a data center may also be utilized to determine whether workloads are to be relocated to the data center. The set of metrics may include power use effectiveness (PUE) of a data center, which is a ratio of total amount of energy used by a data center to energy delivered to computing equipment, such as servers, storage devices, and routers, of the data center. A lower value of PUE indicates a greater efficiency of the data center. The PUE of a data center may be used to determine power and energy that would be consumed by the data center to host a workload. For instance, if a workload is determined to consume 1 KWH and if the PUE of the data center hosting the workload is 1.2, it may be determined that the data center consumes 1.2 KWH (1.2*1 KWH) to host the workload. The PUE of a data center may be utilized to determine whether a target can be achieved by relocating a workload to the data center. For instance, even if the second power cost is less than the first power cost, if the PUE of the second data center 204 is much higher than that of the first data center 202, it may be determined that a movement of the workload to the second data center 204 may not help achieve the TCO target or that a workload is to be moved from the second data center 204 to the first data center 202. The PUE values may also be used to select a target data center to which workloads are to be relocated. For instance, if the second data center 204 has a lower PUE than the third data center 306, the second data center 204 may be selected as a target for hosting the workloads relocated from the first data center 202.

Another metric may be reliability of the computing equipment of the data center. The reliability metric may indicate an extent to which the computing equipment are prone to failure. The reliability may depend on local weather conditions, such as temperature and humidity. Accordingly, the present subject matter facilitates achieving targets of a data center system and data centers powered by various power sources and procuring power at different prices.

Although the relocation of workloads is explained with reference to the TCO target and carbon footprint target, the techniques of the present subject matter can be utilized to achieve various other targets that can be satisfied by relocation of workloads, switching of power supply, or both.

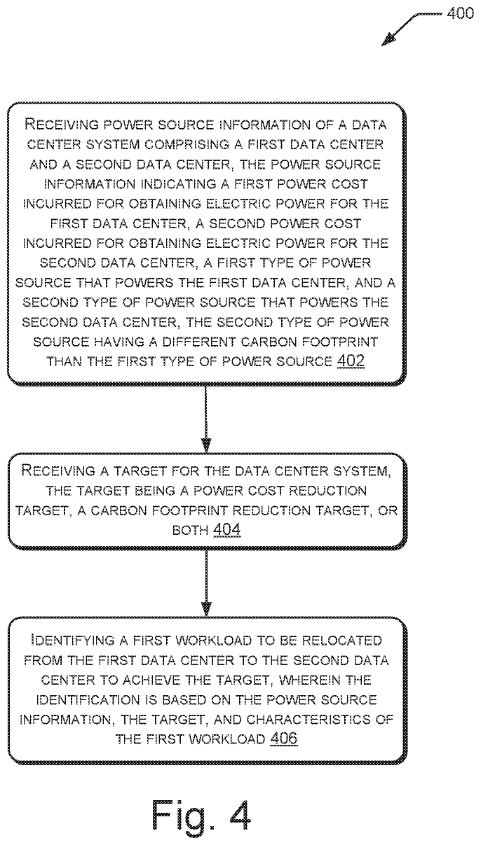

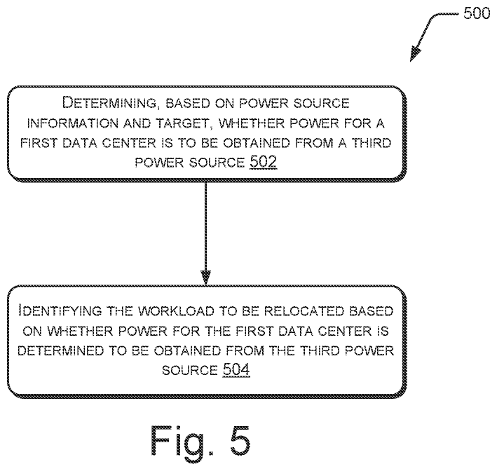

FIGS. 4 and 5 illustrate methods 400 and 500 respectively for facilitating relocation of workloads across data centers, according to example implementations of the present subject matter.

The order in which the methods 400 and 500 is described is not intended to be construed as a limitation, and any number of the described method blocks may be combined in any order to implement the methods 400 and 500, or alternative methods. Furthermore, the methods 400 and 500 may be implemented by processing resource(s) or computing device(s) through any suitable hardware, non-transitory machine-readable instructions, or a combination thereof.

It may be understood that steps of the methods 400 and 500 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. Further, although the methods 400 and 500 may be implemented in a variety of systems, the methods 400 and 500 are described in relation to the system 100, for ease of explanation. In an example, the steps of the methods 400 and 500 may be performed by a processing resource, such as the processor 102.

Referring to method 400, at block 402, power source information of a data center system is received. The data center system may include a first data center, such as the first data center 202, and a second data center, such as the second data center 204. The power source information may be, for example, the power source information 216. The power source information may indicate a first power cost incurred for obtaining electric power for the first data center, a second power cost incurred for obtaining electric power for the second data center, a first type of power source that powers the first data center, and a second type of power source that powers the second data center. The second type of power source may have a different carbon footprint than the first type of power source. For instance, the first type of power source may be a thermal power plant type and the second type of power source may be a solar farm type.

At block 404, a target for the data center system may be received. The target may be, for example, a power cost reduction target or a carbon footprint reduction target. In an example, both the power cost reduction target and the carbon footprint reduction target may be received.

At block 406, a first workload, such as the first workload 206, to be relocated from the first data center to the second data center to achieve the target is identified. The identification may be based on the power source information, the target, and characteristics of the first workload. The characteristics of the first workload may include, for example, power consumption of the first workload, such as the first power consumption. In an example, the characteristics of the first workload may include resource consumption, such as processor consumption, memory consumption, and storage consumption, of the first workload. Further, the identification of the first workload may include computing power consumption of the first workload based on the resource consumption information. Further, in an example, the characteristics of the first workload may include additional information pertaining to the first workload, such as information as to whether the first workload is stateless and performance targets associated with the first workload. The identification based on the workload characteristics and the target may be performed in a manner as explained with reference to FIG. 2.

In an example, in response to receiving the target at block 402, the method 400 may include assessing an amount by which power consumption of the first data center is to be reduced and by which power consumption of the second data center is to be increased, to achieve the target. Such an assessment may be based on the power source information and the target, as explained with reference to FIG. 2. Further, the identification at block 406 may include identifying, from among a plurality of workloads hosted on the first data center, a set of workloads, including the first workload, for relocation to the second data center. The power consumption of the set of workloads corresponds to the assessed amount of power consumption. The identification may be based on characteristics of the plurality of workloads.

In an example, the data center system may include a third data center, such as the third data center 306. The power source information may indicate a fourth power cost incurred for obtaining electric power for the third data center and a type of power source that powers the third data center, such as the fourth power source 308. Accordingly, the method 400 may include selecting, from among the second data center and the third data center, the second data center for relocation of the first workload based on the power source information, as explained with reference to FIG. 3. The selection of the second data center may also be based on a power user effectiveness (PUE) of the second data center and a PUE of the third data center. For instance, a data center having lesser PUE may be selected. The method 400 may further include identifying a second workload hosted on the first data center for relocation to the third data center to achieve the target.

In an example, instead of, or in addition to, relocation of workloads, a power source that supplies power to the data center may be switched, as will be explained below.

FIG. 5 illustrates a method 500 for determining whether a power source that supplies power to the first data center is to be switched and whether a workload is to be relocated, according to an example implementation of the present subject matter. In an example, the first data center may be powered by a first power source of a first type, the second data center may be powered by a second power source of a second type. Further, the power source information may indicate a third power cost at which electric power is deliverable to the first data center from a third power source, such as the third power source 302, and a type of the third power source.

At block 502, based on the power source information and the target, it may be determined as to whether power for the first data center is to be obtained from the third power source, as explained with reference to FIG. 3. At block 504, the identification of the first workload for relocation may be performed based on whether power for the first data center is determined to be obtained from the third power source. For instance, as explained with reference to FIG. 3, it may be determined that workload relocation is not to be performed from the first data center if the power source is switched to the third power source. As another example, the number of workloads or type of workloads (whether heavy or light) to be relocated may be higher if the power source is not to be switched than if the power source is to be switched.

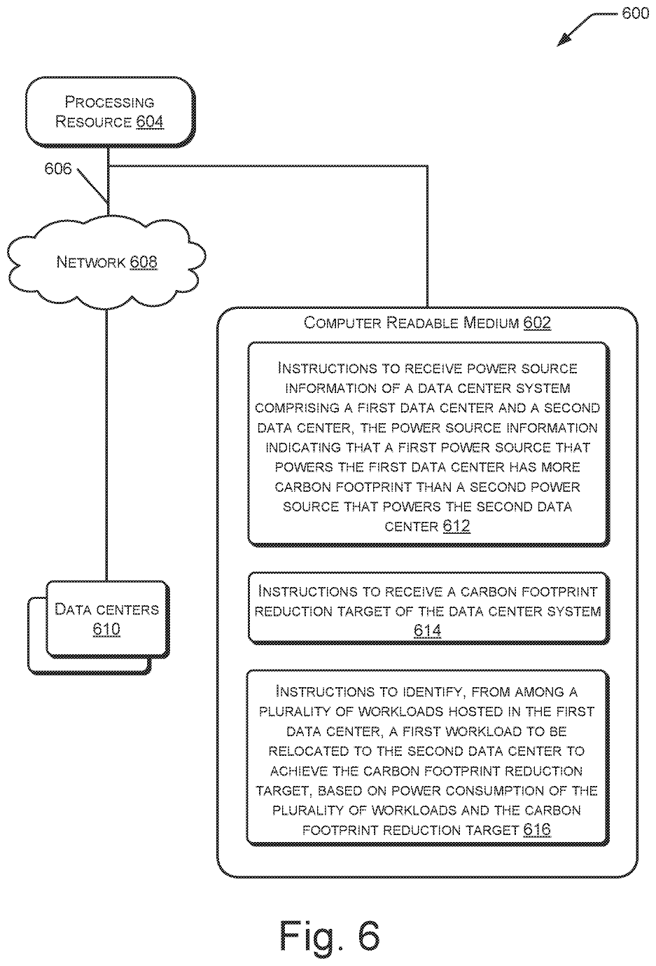

FIG. 6 illustrates a computing environment 600 implementing a non-transitory computer-readable medium 602 for facilitating relocation of workloads across data centers, according to an example implementation of the present subject matter.

In an example, the non-transitory computer-readable medium 602 may be utilized by a system, such as the system 100. In an example, the computing environment 600 may include a processing resource 604 communicatively coupled to the non-transitory computer-readable medium 602 through a communication link 606. The processing resource 604 may be, for example, the processor 102.

The non-transitory computer-readable medium 602 may be, for example, an internal memory device or an external memory device. In an example, the communication link 606 may be a direct communication link, such as any memory read/write interface. In another example, the communication link 606 may be an indirect communication link, such as a network interface. In such a case, the processing resource 604 may access the non-transitory computer-readable medium 602 through a network 608. The network 608 may be a single network or a combination of multiple networks and may use a variety of different communication protocols.

The processing resource 604 and the non-transitory computer-readable medium 602 may also be communicatively coupled to data centers 610 of a data center system over the network 608. The data center system may be, for example, the data center system 200. Further, the data centers 610 may include a first data center, such as the first data center 202, and a second data center, such as the second data center 204.

In an example implementation, the non-transitory computer-readable medium 602 includes a set of computer-readable instructions to facilitating relocation of workloads across data centers. The set of computer-readable instructions can be accessed by the processing resource 604 through the communication link 606 and subsequently executed.

Referring to FIG. 6, in an example, the non-transitory computer-readable medium 602 includes instructions 612 that cause the processing resource 604 to receive power source information of the data center system. The power source information may indicate that a first power source that powers the first data center has more carbon footprint than a second power source that powers the second data center. The power source information may be the power source information 216. In an example, the first power source may be a renewable power source and the second power source may be a non-renewable power source.

The non-transitory computer-readable medium 602 includes instructions 614 that cause the processing resource 604 to receive a carbon footprint reduction target for the data center system. The carbon footprint may indicate, for example, an amount by which carbon footprint of the data center system has to be reduced as compared to a previous year. The non-transitory computer-readable medium 602 includes instructions 616 that cause the processing resource 604 identify, from among a plurality of workloads hosted in the first data center, a first workload to be relocated to the second data center to achieve the carbon footprint reduction target. The identification may be based on power consumption of each of the plurality of workloads and the carbon footprint reduction target, as explained with reference to FIG. 2. In an example, to identify a workload for relocation, the instructions are executable to consider additional information pertaining to each workload. The additional information includes information as to whether the workload is stateless and performance targets associated with the workload.

Prior to the relocation of the first workload, in an example, the instructions are executable to repurpose the second data center to facilitate the second data center to host the first workload, as explained with reference to FIG. 2.

In an example, the power source information further indicates a first power cost at which power from the first power source is supplied to the first data center and a second power cost at which power from the second power source is supplied to the second data center. Further, the non-transitory computer-readable medium 602 includes instructions that cause the processing resource 604 receive a power cost reduction target for the data center system. The instructions may cause selection of a second workload from among the plurality of workloads to be relocated to the second data center, to achieve the power cost reduction target. The selection may be based on the characteristics of the plurality of workloads, the first power cost, the second power cost, and the TCO reduction target. The second workload may then be relocated from the first data center to the second data center.

In an example, the power source information further indicates that a third power source is capable of supplying electric power to the first data center and that the third power source has a carbon footprint less than the first power source. In such a case, the instructions are executable by the processing resource to receive the power cost reduction target for the data center system. Further, based on the carbon footprint reduction target, the power cost reduction target, and the power source information, the instructions cause the processing resource 604 to first determine whether power for the first data center is to be obtained from the third power source, as explained with reference to FIG. 3. Further, the processing resource 604 may then determine whether a workload is to be relocated to the second data center from the first data center based on a result of the first determination. For instance, if it is determined that the power source is to be switched, it may be determined that no workload is to be relocated to the second data center, as explained earlier.

The present subject matter facilitates reducing TCO and carbon footprint of an organization having a data center system. By analyzing targets of an organization, cost information, and characteristics of workloads, the present subject matter facilitates accurately identifying the workloads that are to be relocated to achieve targets. Therefore, techniques of the present subject matter can achieve quantitative targets pertaining to power consumption of the data centers.

Further, the switching of a power source from which the power for a data center is obtained also facilitates achieving the targets. By taking a decision as to whether a workload is to be relocated based on a decision as to whether the power source is to be switched and vice-versa, the present subject matter facilitates making well-informed decisions for achieving the targets.

The repurposing of data centers prior to migration of workloads facilitates relocation of workloads with minimal disruption. Further, the consideration of a variety of characteristics, such as statelessness, performance targets, and the like, makes the process of workloads for selection a more efficient one. The present subject matter can be utilized by organizations that operate a plurality of on-prem data centers.

Although implementations of relocation of workloads across data centers have been described in language specific to structural features and/or methods, it is to be understood that the present subject matter is not necessarily limited to the specific features or methods described. Rather, the specific features and methods are disclosed and explained as example implementations.

I/We claim:

1. A method comprising:
receiving power source information of a data center system comprising a first data center and a second data center, the power source information indicating a first power cost incurred for obtaining electric power for the first data center, a second power cost incurred for obtaining electric power for the second data center, a first type of power source that powers the first data center, and a second type of power source that powers the second data center, the second type of power source having a different carbon footprint than the first type of power source;
receiving a target for the data center system, the target being a power cost reduction target, a carbon footprint reduction target, or both; and
identifying a first workload to be relocated from the first data center to the second data center to achieve the target, wherein the identification is based on the power source information, the target, and characteristics of the first workload.

2. The method of claim 1, wherein characteristics of the first workload comprises power consumption of the first workload and wherein, in response to receiving the target, the method comprises:
assessing, based on the power source information and the target, an amount by which power consumption of the first data center is to be reduced to achieve the target,
wherein, identifying the first workload to be relocated comprises:
identifying, from among a plurality of workloads hosted on the first data center, a set of workloads comprising the first workload for relocation to the second data center, wherein power consumption of the set of workloads corresponds to the assessed amount of power consumption, and wherein the identification is based on characteristics of the plurality of workloads.

3. The method of claim 1, wherein the first data center is powered by a first power source of the first type, wherein the second data center is powered by a second power source of the second type, and wherein the power source information further indicates:
a third power cost at which electric power is deliverable to the first data center from a third power source; and
a type of the third power source,
wherein the method comprises:
determining, based on the power source information and the target, whether power for the first data center is to be obtained from the third power source.

4. The method of claim 3, comprising identifying the first workload for relocation based on whether power for the first data center is determined to be obtained from the third power source.

5. The method of claim 1, wherein characteristics of the first workload comprises resource consumption information of the first workload and wherein identifying the first workload comprises:
computing power consumption of the first workload based on the resource consumption.

6. The method of claim 1, wherein the data center system further comprises a third data center, wherein the power source information further indicates a fourth power cost incurred for obtaining electric power for the third data center and a type of power source that powers the third data center,
wherein the method comprises:
selecting, from among the second data center and the third data center, the second data center for relocation of the first workload based on the power source information.

7. The method of claim 6, further comprising identifying a second workload hosted on the first data center for relocation to the third data center to achieve the target.

8. The method of claim 6, comprising selecting the second data center based on:
a power user effectiveness (PUE) of the second data center, the PUE of the second data center being a ratio of total amount of energy used by the second data center to energy delivered to computing equipment of the second data center; and
a PUE of the third data center.

9. A system comprising:
a processor, and
a memory coupled to the processor and storing instructions executable by the processor to:
receive power source information of a data center system comprising a first data center and a second data center, the power source information indicating a first power cost incurred for obtaining electric power for the first data center, and a second power cost incurred for obtaining electric power for the second data center;
receive a power cost reduction target for the data center system; and
identify, from among a first plurality of workloads hosted in the first data center, a first workload to be relocated to the second data center to achieve the power cost reduction target, wherein the identification is based on characteristics of the first plurality of workloads, the power source information, and the power cost reduction target.

10. The system of claim 9, wherein the power source information further indicates a first carbon footprint of a first power source that powers the first data center and a second carbon footprint of a second power source that powers the second data center,
wherein the instructions are executable by the processor to:
receive a carbon footprint reduction target of the data center system; and
identify, from among the first plurality of workloads, a second workload to be relocated to the second data center, wherein the identification is based on the characteristics of the first plurality of workloads, the first carbon footprint, the second carbon footprint, and the carbon footprint reduction target.

11. The system of claim 9, wherein the power source information further indicates a first carbon footprint of a first power source that powers the first data center, a third carbon footprint of a third power source that is capable of delivering power to the first data center, and a third power cost at which electric power is deliverable to the first data center from the third power source, wherein the instructions are executable by the processor to:
receive a carbon footprint reduction target of the data center system; and
determine, based on the power source information, the power cost reduction target, and the carbon footprint reduction target, whether power for the first data center is to be obtained from the third power source.

12. The system of claim 11, wherein the instructions are executable by the processor to identify the first workload for relocation based on whether power for the first data center is determined to be obtained from the third power source.

13. The system of claim 11, wherein the instructions are executable by the processor to:
receive a target for the first data center; and
determine whether electric power is to be obtained from the third power source based on the target for the first data center.

14. The system of claim 9, wherein the instructions are executable to determine that the power cost reduction target is achievable by relocation of workloads to the second data center based on a power user effectiveness (PUE) of the second data center, the PUE of the second data center being a ratio of total amount of energy used by the second data center to energy delivered to computing equipment of the second data center.

15. The system of claim 9, wherein, prior to relocation of the first workload to the second data center, the instructions are executable by the processor to determine whether the second data center has sufficient resources for hosting the first workload.

16. A non-transitory computer-readable medium comprising instructions, the instructions being executable by a processing resource to:
receive power source information of a data center system comprising a first data center and a second data center, the power source information indicating that a first power source that powers the first data center has more carbon footprint than a second power source that powers the second data center;
receive a carbon footprint reduction target for the data center system; and
identify, from among a plurality of workloads hosted in the first data center, a first workload to be relocated to the second data center to achieve the carbon footprint reduction target, based on power consumption of each of the plurality of workloads and the carbon footprint reduction target.

17. The non-transitory computer-readable medium of claim 16, wherein the power source information further indicates a first power cost at which electric power from the first power source is supplied to the first data center and a second power cost at which electric power from the second power source is supplied to the second data center, wherein the instructions are executable by the processing resource to:
receive a power cost reduction target for the data center system; and
identify, from among the plurality of workloads, a second workload to be relocated to the second data center to achieve the power cost reduction target, wherein the identification is based on the power consumption of each of the plurality of workloads, the first power cost, the second power cost, and the power cost reduction target.

18. The non-transitory computer-readable medium of claim 17, wherein, to identify the first workload from among the plurality of workloads, the instructions are executable to consider additional information pertaining to each workload, wherein additional information pertaining to a workload comprises information as to whether the workload is stateless and performance targets associated with the workload.

19. The non-transitory computer-readable medium of claim 16, wherein the power source information further indicates a first power cost at which electric power from the first power source is supplied to the first data center, a second power cost at which electric power from the second power source is supplied to the second data center, that a third power source is capable of supplying electric power to the first data center, and that the third power source has a carbon footprint less than the first power source, wherein the instructions are executable by the processing resource to:
receive a power cost reduction target for the data center system; and
based on the carbon footprint reduction target, the power cost reduction target, and the power source information,
perform a first determination as to whether power for the first data center is to be obtained from the third power source; and
perform a second determination as to whether a workload is to be relocated to the second data center from the first data center based on a result of the first determination.

20. The non-transitory computer-readable medium of claim 16, wherein, in response to identification of the first workload for relocation and prior to the relocation, the instructions are executable to repurpose the second data center to facilitate the second data center to host the first workload.
